(19) United States
(12) Patent Application Publication
(10) Pub. No.: US 2023/0188954 A1
(43) Pub. Date: Jun. 15, 2023

(54) METHOD FOR NOTIFYING A MOBILE TERMINAL

(71) Applicant: Orange, Issy-les-Moulineaux (FR)

(72) Inventor: Bertrand Bouvet, CHÂTILLON CEDEX (FR)

(21) Appl. No.: 17/999,325

(22) PCT Filed: May 12, 2021
(86) PCT No.: PCT/FR2021/050829

§ 371 Date: Nov. 18, 2022

(30) Foreign Application Priority Data
May 19, 2020 (FR) 2005091

(51) Int. Cl. H04W 4/20; H04W 40/24; H04W 12/06

(52) U.S. Cl. CPC H04W 4/20; H04W 40/24; H04W 12/06

(57) ABSTRACT

A method is described for transmitting a notification to an application of a mobile terminal having a secure hardware element allowing the authentication of said mobile terminal in a telecommunications network. The method includes receiving a notification from an application server, the notification including at least one identifier of the mobile terminal and at least one identifier of the application, obtaining, depending on the at least one identifier of the mobile terminal, at least one item of connectivity data, determining, depending on the obtained item of connectivity data, an access parameter for access to at least one communication device able to communicate with the mobile terminal, and transmitting the notification to the communication device accessible via the access parameter.

### 1. FIELD OF THE INVENTION

The invention relates to the general field of telecommunication networks, and more particularly mobile terminals.

### 2. PRIOR ART

Most operating systems used by mobile terminals (Apple IOS, Google Android, etc.) provide means for receiving, from a service platform of the operating system provider and accessible from the Internet network, notifications (APNS for the Apple IOS operating system, GCM/FCM for the Google Android operating system) intended for applications present on the terminals. These notifications are used, for example, to “wake up” an application when it is not running, or to provide it with information in quasi-real time when it is running in the background. Once the notification(s) has/have been received, the application is able to inform the user of the content of the notification (incoming call, code input request during banking transaction, etc.) via a man-machine interface of the mobile terminal.

The operation of a service of this type is based on the declaration of a user account in the mobile terminal allowing the use by said mobile terminal of a service platform of the operating system provider. Once the account has been declared, a secure and permanent communication channel is established between the operating system and/or an application of the operating system provider present on the terminal (for example the Google Play application for Android) and the service platform of the operating system provider. This communication channel serves, for example, to inform the service platform of the operating system provider of a change of IP Internet address of the network interface of the mobile terminal, to inform the mobile terminal of the availability of an operating system and/or application update, and to transmit notifications, for example from application servers, to the applications present on the terminal.

When the user downloads an application from the service platform of the operating system provider onto his mobile terminal, said service platform generates and stores a unique identifier of the application downloaded onto the terminal in a profile of the user. Once launched, the application retrieves the unique identifier from the service platform of the operating system provider and transmits it to the application servers which provide it with some or all of the information/services proposed to the user. Thus, when one of the application servers wishes to send a notification to the application, it transmits the different information to be sent plus the previously retrieved unique identifier of the application to the service platform of the operating system provider.

This notification mechanism implemented by the mobile operating system providers is essential and has no known alternative to guarantee a good user experience with the mobile applications. This mechanism also serves to optimize the power consumption of the mobile terminal and the network bandwidth. It is in fact not then necessary for an application to transmit requests regularly to an application platform located in the network to retrieve, for example, messages or information intended for the application user. The terminal and the applications will be “woken up” when necessary.

However, this notification system relies on the availability of an IP Internet connectivity of the terminal. Consequently, if the user deactivates the cellular data of his terminal and there is no other available connectivity such as Wi-Fi, the permanent communication channel between the terminal and the service platform of the operating system provider becomes disabled. This system further requires, on one hand, special engineering in the IP equipment of the telecommunication operators in order to maintain this permanent communication channel and, on the other hand, a minimum data rate once the authorized data quota linked to the subscription has been reached.

A fragmentation of the notification solutions also exists depending on the mobile operating system providers, each one proposing its own solution which is incompatible with the other solutions available on the market. For the application server providers, this entails the implementation of all the notification solutions in such a way as to provide the same user experience to all users, regardless of the type of mobile terminal owned.

The service platform of the operating system provider can further access potentially sensitive data contained in the notifications, which may cause a problem in terms protecting the personal data. In fact, a malicious operator offering such a service could, for example, retrieve user data and resell them without the users being aware of it.

Generally speaking, the use of these service platforms also results in an increase in international IP traffic, since most of these platforms are hosted in the USA, which may involve the use of a large quantity of network equipment to route the notifications to the terminals of users who are not resident in the USA, having a significant impact in terms of energy and therefore the environment.

Furthermore, there is no alternative solution to solutions of this type. Specifically, if the service platform of a mobile operating system provider is inaccessible, for example as a result of an update problem, the mobile applications which use the notification system lose some or all of the functionalities.

### 3. DESCRIPTION OF THE INVENTION

The invention improves the prior art and for this purpose proposes a method for transmitting a notification to an application of a mobile terminal, said mobile terminal having a secure hardware element allowing the authentication of said mobile terminal in a telecommunication network, the method being characterized in that it comprises:

a step of receiving said notification from an application server, said notification comprising at least one identifier of said mobile terminal and at least one identifier of said application;

a step of obtaining at least one connectivity datum depending on said at least one identifier of said mobile terminal;

a step of determining, depending on said at least one connectivity datum, an access parameter for access to at least one communication device able to communicate with said mobile terminal;

a step of transmitting said notification to said communication device accessible via said access parameter.

When a service wishes to notify a mobile application, the transmission method according to the invention advantageously allows the notification to be transmitted via a communication device able to communicate with the mobile terminal which runs the mobile application receiving the notification. The communication device is determined depending on a connectivity datum itself obtained depending on an identifier of the mobile terminal.

Specifically, for example for a given mobile terminal, the method obtains connectivity data of the mobile terminal depending, for example, on the MSISDN (Mobile Station International Subscriber Device Number) contained in the notification. The method then processes these connectivity data and derives therefrom the connectivity to be used, such as, for example, SMS (Short Message Service), USSD (Unstructured Supplementary Service Data), a phone call, etc., to communicate with the mobile terminal. A communication device compatible with the connectivity chosen by the device and an associated access parameter are then determined by the method. The notification is then sent to the mobile terminal and to the receiving application via the communication device.

It should be noted that, in the obtaining step, it is possible to use a second identifier of the terminal, for example obtained via a database depending on the identifier contained in the notification. An identifier of the receiving mobile terminal such as an MSISDN contained in the notification can, for example, allow the telephone operator responsible for this MSISDN to obtain a MAC (Media Access Control) address of the mobile terminal which will then be used to obtain a connectivity datum of the mobile terminal.

A secure hardware element is understood to mean any hardware element inside the mobile terminal able to provide a secure environment such as, for example, an eSE (embedded Secure Element), a TEE (Trusted Execution Environment) or a removable medium managed by the mobile terminal such as, for example, a subscriber card such as a SIM/eSIM (Subscriber Identification Module)/eSIM (Embedded Subscriber Identification Module), a UICC (Universal Integrated Circuit Card), a memory card or an external terminal/device connected to the mobile terminal via a secure link. This secure element is used, for example, to store the necessary information allowing the authentication of the mobile terminal and/or its owner with a network of a mobile telecommunication operator.

An application is understood to mean computer software developed to be executed on a mobile terminal such as a telephone, a portable computer, a connected object, a connected vehicle, a tablet, etc. The mobile application can also be a JavaCard or Cardlet applet capable of being executed on a UICC/eSE/SIM/etc.

An access parameter is understood to mean a parameter which allows access to and establishment of communication with a communication device, such as a messaging address, an IP address, a MAC address, an FQDN (Fully Qualified Domain Name), etc.

A connectivity datum is understood to mean a datum indicating some or all of the available connectivities on a computing device such as Bluetooth, WiFi, LiFi, LoRa, cellular (5G/4G/4G/2G), an IP address and their states (active or inactive).

A terminal identifier is understood to mean a string of binary characters and/or data serving to identify a terminal, such as a call number (MSISDN), a messaging address, an IP address, a MAC address, an IMEI, an IMSI, a TEID (Terminal End Point Identifier), a token (identifying and/or authenticating the terminal), etc.

An application identifier is understood to mean a string of binary characters and/or data, such as, for example, a token identifying an application and/or a content and/or an action interpretable by an application on a mobile terminal.

According to one particular embodiment of the invention, a method as described above is characterized in that the transmission step comprises a substep of routing said notification by said communication device to said application of said mobile terminal identified via said at least one identifier of said mobile terminal.

This embodiment of the invention allows the mobile terminal to be identified from among a plurality of terminals and allows the notification to be transmitted to it. The terminal is identified via one, a plurality, or a combination of these identifiers. Routing is understood to mean the capacity to direct/send/transfer a notification to the receiving mobile terminal.

According to one particular embodiment of the invention, a method as described above is characterized in that the obtaining step also depends on said identifier of said application.

This embodiment of the invention allows a connectivity to be chosen from among a plurality of available connectivities on a mobile terminal depending on the application receiving the notification. This allows, for example, the most suitable connectivity to be chosen for the transmission of the notification, such as, for example, the fastest or the least energy-intensive.

According to one particular embodiment of the invention, a method as described above is characterized in that the reception step is followed by a step of storing said notification.

This embodiment of the invention allows, for example, the received notification with its content to be stored in a memory accessible using the transmission method. The information saved/stored in this way can then be restored to the application, for example following a request sent by the application.

According to one particular embodiment of the invention, a method as described above is characterized in that said at least one connectivity datum comprises the connection state of at least one communication interface of said mobile terminal at a given time.

This embodiment of the invention serves to choose a communication device and a parameter for access to it depending on a connection state, for example active or inactive, of a communication interface/service of the mobile terminal at a given time. It is thus possible to ensure that the mobile terminal actually has an active communication interface/service before transmitting the notification to it via a suitable communication device.

According to one particular embodiment of the invention, a method as described above is characterized in that said at least one connectivity datum comprises a priority indicator associated with said at least one communication interface of said mobile terminal.

This embodiment serves to choose the communication interface or service to be used from among a plurality of active communication interfaces/services at a given time via, for example, a classification (order of preference) or a waiting associated with each communication interface/service.

According to one particular embodiment of the invention, a method as described above is characterized in that said at least one connectivity datum comprises a quality indicator associated with said at least one communication interface of said mobile terminal.

This embodiment serves to choose the communication interface or service to be used from among a plurality of active communication interfaces/services at a given time depending on a quality indicator such as, for example, the radio reception quality determined in the communication interface/service of the mobile terminal.

According to one particular embodiment of the invention, a method as described above is characterized in that the determination step also depends on an access rights datum associated with the secure hardware element.

This embodiment serves to choose a communication device from among a plurality of communication devices depending on access rights, for example assigned by a telecommunication operator to the owner of the mobile terminal. The commercial offering (subscription) provided by the telecommunication operator to the owner of the mobile terminal and associated with the security element can comprise access restrictions for the mobile terminal to one or more communication devices, for example platforms such as SMS/MMS/USSD/telephony/etc. The restrictions can be temporary, for example linked to a time period or to a data exchange quota, or total if the subscription does not include the facility to use a particular platform.

According to one particular embodiment of the invention, a method as described above is characterized in that said at least one connectivity datum comprises the connection state of at least one server located in the network.

This embodiment of the invention serves to choose a communication device and a parameter for access to it depending on a connection state, for example active or inactive, of a communication interface of a server located in the network. It is thus possible to ensure that the server is actually connected/accessible before transmitting the notification to it via a suitable communication device. This allows, for example, the error codes returned by the server or the lack of response within a given time period to be taken into account.

The invention also relates to a method for receiving a notification, implemented by a mobile terminal, said notification being intended for a service application of said mobile terminal, the method being characterized in that it comprises:

a step of receiving said notification from a communication device by an operator application, said notification comprising at least one identifier of said service application;

a step of waking up said service application via a message sent by said operator application;

a step of transmitting said notification to said service application.

The reception method according to the invention advantageously enables the reception on a mobile terminal of the notification transmitted from a communication device. Once received, the notification is then transmitted to the receiving service application.

An operator application is understood to mean an application capable of being woken up by means of a signaling message received in a radiocommunication interface/service of the mobile terminal.

According to one particular embodiment of the invention, a reception method as described above is characterized in that said identifier of said service application comprises a link enabling access to a specific content of said application.

This embodiment of the invention serves, for example, to notify the service application that a particular content must be restored to the user.

According to one particular embodiment of the invention, a reception method as described above is characterized in that said identifier of said service application comprises a link enabling the downloading by said service application of at least one information element from a server located in the network.

This embodiment of the invention serves, for example, to notify the service application that a particular content is, for example, downloadable from a server located in the network. The link can, for example, comprise an identifier of the notification allowing identification of the content to be downloaded.

An identifier of a notification is understood to mean a string of binary characters and/or data which serves to identify a notification uniquely or otherwise. The identifier can, for example, be the same for a plurality of notifications and can correspond to a notification category enabling the instigation of a particular processing in the mobile terminal.

The invention also relates to a transmission device for transmitting a notification to an application of a mobile terminal, said mobile terminal having a secure hardware element allowing the authentication of said mobile terminal in a telecommunication network, said device being characterized in that it comprises:

a reception module for receiving said notification from an application server, said notification comprising at least one identifier of said mobile terminal and at least one identifier of said application;

an obtaining module for obtaining at least one connectivity datum depending on said first identifier of said mobile terminal;

a determination module for determining, depending on said at least one connectivity datum, an access parameter for access to at least one communication device able to communicate with said mobile terminal;

a transmission module for transmitting said notification to said communication device via said determined access parameter.

The term “module” can correspond equally to a software component and a hardware component or to a set of hardware and software components, a software component itself corresponding to one or more computer programs or subprograms or, more generally, to any element of a program able to implement a function or a set of functions as described for the modules concerned. Similarly, a hardware component corresponds to any element of a hardware set able to implement a function or a set of functions for the module concerned (integrated circuit, chip card, memory card, etc.).

According to one particular embodiment of the invention, a transmission device as described above is characterized in that it includes said communication device.

The invention also relates to a server comprising a transmission device as described above.

The invention also relates to a transmission system for transmitting a notification to an application of a mobile terminal, said mobile terminal having a secure hardware element allowing the authentication of said mobile terminal in a telecommunication network, characterized in that it comprises:

a first device comprising means for receiving said notification from an application server, said notification comprising at least one identifier of said mobile terminal and at least one identifier of said application, obtaining at least one connectivity datum depending on said identifier of said mobile terminal, determining an access parameter for access to at least one communication device depending on said at least one obtained connectivity datum, and transmitting said notification to said communication device;

a second device, i.e. a communication device, accessible via said access parameter comprising means for receiving said notification and routing it to said mobile terminal depending on said at least one identifier of said mobile terminal.

According to one particular embodiment of the invention, a system as described above is characterized in that said communication device comprises a server of a telecommunication operator able to communicate with said mobile terminal.

A server of a telecommunication operator is understood to mean a server operated by an operator providing a mobile communication service to the owner of the mobile terminal. This means the operator owning the secure hardware element and/or the data stored there (profile) enabling the mobile terminal to identify itself in the network and the platforms in order to obtain communication services.

The server can, for example, comprise a server such as a GGSN (Gateway GPRS Support Node) server and/or PGW (Packet Gateway) and/or SMF (Session Management Function) and/or UPF (User Plane Function) and/or SMS-C (Short Message Service Center) and/or IP-SM-GW (IP Short Message Gateway) and/or MMS-C (Multimedia Message Service Center) and/or USSD/USSI (Unstructured Supplementary Service Data/Unstructured Supplementary Service over IP) server and/or MSC (Mobile Switch Center) and/or TAS (Telephony Application Server) of an IMS (IP Multimedia subsystem) network and/or an RCS (Rich Communication Suite) and/or MME (Mobility Management Entity) and/or AMF (Access and Mobility Management), etc.

The invention also relates to a management system for managing a notification, said notification being intended for an application of a mobile terminal, characterized in that it comprises:

a first device comprising means for transmitting said notification, the latter comprising at least one first identifier of said mobile terminal and at least one identifier of said application;

a second device comprising means for receiving said notification from an application server, said notification comprising at least one identifier of said mobile terminal and at least one identifier of said application, obtaining at least one connectivity datum depending on said identifier of said mobile terminal, determining an access parameter for access to at least one communication device depending on said at least one obtained connectivity datum, and transmitting said notification to said communication device;

a third device, i.e. a communication device, accessible via said access parameter comprising means for receiving said notification and routing it to said mobile terminal depending on said at least one identifier of said mobile terminal;

a terminal comprising means for receiving said notification from said communication device and waking up said application identified via said at least one identifier of said application.

The invention also relates to a computer program comprising instructions for implementing the method above according to any one of the previously described particular embodiments when said program is executed by a processor. The method can be implemented in various ways, in particular in wired form or in software form. This program can use any programming language and can be in the form of source code, object code or intermediate code between source code and object code, such as in a partially compiled form, or in any other desirable form.

The invention also relates to a recording medium or computer-readable information medium comprising instructions of a computer program as mentioned above. The aforementioned recording media may be any given entity or device able to store the program. For example, the medium may comprise a storage means, such as a ROM, for example a CD-ROM or microelectronic circuit ROM, or a magnetic recording means, for example a hard disk. The recording media may further correspond to a transmissible medium such as an electrical or optical signal which can be routed via an electrical or optical cable, by radio or by other means. The programs according to the invention can, in particular, be downloaded from an Internet network.

Alternatively, the recording media can correspond to an integrated circuit into which the program is incorporated, the circuit being suitable for carrying out or for being used in the carrying out of the method in question.

This transmission device and this transmission system, and also this computer program have characteristics and advantages similar to those previously described in connection with the transmission and reception methods.

### 4. LIST OF FIGURES

Other characteristics and advantages of the invention will become clearer from a reading of the following description of particular embodiments, given as simple, illustrative and non-limiting examples, and the attached drawings, in which:

FIG. 1 shows an example of an implementation environment according to one particular embodiment of the invention,

FIG. 2 shows the steps of the method for transmitting a notification according to one particular embodiment of the invention,

FIG. 3 shows the architecture of a system implementing the invention according to one particular embodiment,

### 5. DESCRIPTION OF AN EMBODIMENT OF THE INVENTION

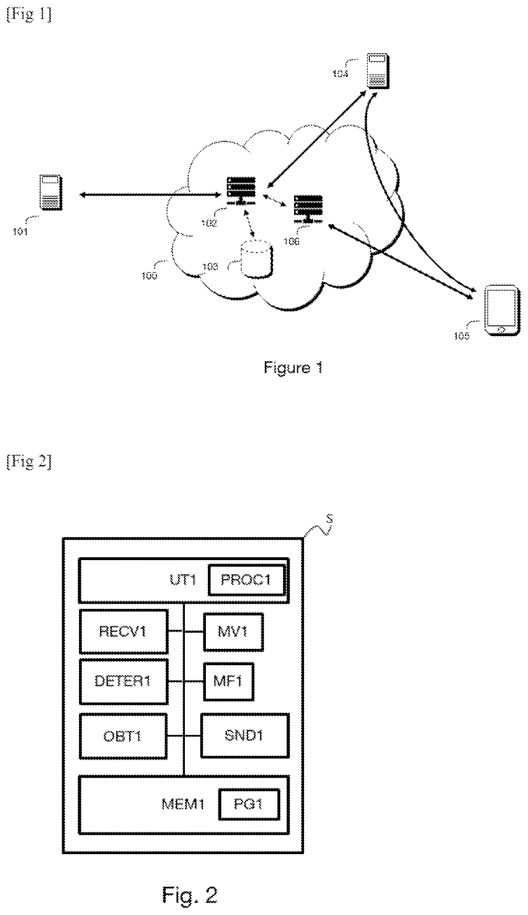

FIG. 1 shows an example of an implementation environment according to one particular embodiment of the invention. The implementation environment comprises a terminal 105 suitable for establishing communications with a server 106 located in the network of a telecommunication operator 100 or a server 104 of a third party accessible from the communication network 100 according to the prior art. The terminal 105 is, for example, a mobile terminal comprising a security element such as an iSIM/eSIM/eSE/TEE component able to store information allowing the terminal to authenticate itself then connect to the network 100. It should be noted that the security element can also be a removable medium managed by the mobile terminal, such as, for example, a SIM/UICC (for “Universal Integrated Circuit Card”) subscriber card, or a memory card. The server 106 is a server able to establish communications with the terminal 105, such as an SMS-C, IP-SM-GW, MMS-C server, a USSD/USSI, MSC, PGW, SMF, UPF, GGSN, TAS, RCS, MME, AMF, etc., server.

The implementation environment also comprises an application server 101, accessible from the communication network 100 and able to transmit notifications to an application running on the terminal 105 or on the security element. The application can be a JavaCard application run, for example, on the security element, or a higher-level application run in the OS (Operating System) of the terminal.

The server 104 is, for example, a server operated by a third party such as an APNS Apple or GCM/FCM Google notification server able to transmit notifications to an application run in the OS (Operating System) of the terminal.

The server 102 is a server operated by the telecommunication operator of the telecommunication network 100 able to communicate with the servers 101, 104 and 106.

According to one particular embodiment of the invention, the implementation environment also comprises a database 103 accessible from the server 102 and located in the telecommunication network 100, configured to store connectivity data indicating some or all of the connectivities available in the terminal 105 and/or the server 104 with their states (active/inactive/etc.). Each connectivity datum can be associated with one or more connectivities of the terminal 105 or the server 104. For each connectivity datum, the database 103 can also store one or more access parameters for access to communication devices, such as an IP address, a MAC address, a URI (Uniform Resource Identifier), an FQDN (Fully Qualified Domain Name) allowing access to and establishment of communication with a communication device such as the server 106.

According to one particular embodiment, the servers 102 and 106 are the same server.

According to one particular embodiment, the servers 101 and 102 are the same server. It should be noted that the server comprising the servers 101 and 102 can be located inside the telecommunication network 100 if, for example, this server is operated by the telecommunication operator of the network 100, or outside if, for example, this server is a server operated by an aggregator.

According to one particular embodiment, the database 103 can store the notifications from the server 101.

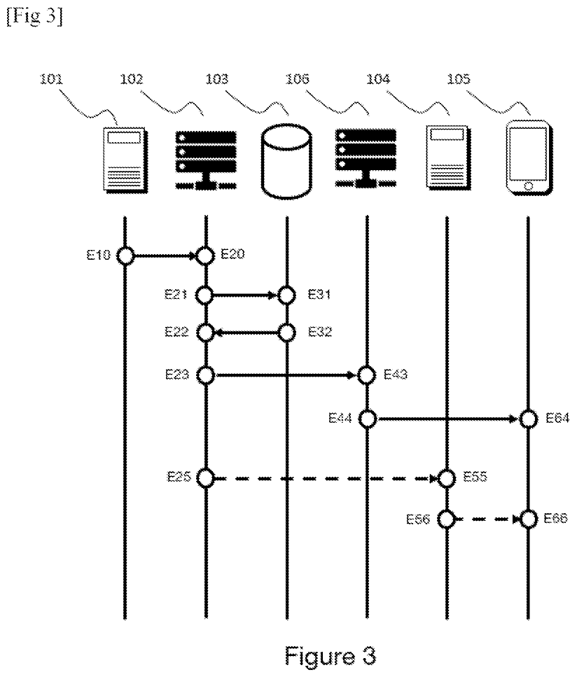

FIG. 2 shows the hardware architecture of a device S configured to carry out the method for transmitting a notification according to one particular embodiment of the invention. In the embodiment described here, this device has the hardware architecture of a computer. It comprises, in particular, a processor PROC1, a RAM memory MV1, a ROM memory MEM1 and a non-volatile flash memory volatile MF1. Such means are known per se and are not described in more detail here. The ROM memory consists of a recording medium according to the invention, readable by the processor PROC1, on which a computer program PG1 according to the invention is recorded, this program comprising instructions to implement the steps of the method for transmitting a notification as described above, when the program is executed by the processor PROC1. On initialization, the code instructions of the computer program PG1 are, for example, loaded into a memory before being executed by the processor PROC1. The processor PROC1 of the processing unit UT1 implements, in particular, the steps of the method for transmitting a notification according to any one of the particular embodiments described in relation to FIGS. 1 and 3, according to the instructions of the computer program PG1.

The device S also comprises a reception module RECV1 able to receive communications via, for example, an IP network. The reception module RECV1 is used, for example, to receive notifications from an application server, such as, for example, the server 101. The device S further comprises a transmission module SND1 able to transmit communications via, for example, an IP network. The transmission module SND1 is used, for example, to transmit the notification received via the module RECV1 to an application of a terminal such as the terminal 105.

The device S further comprises an obtaining module OBT1 able to obtain one or more connectivity data of a device such as the server 104 or the terminal 105 from, for example, a storage space such as an internal memory or a database. The connectivity datum/data is/are obtained depending on one or more identifiers contained in the notification. The identifiers can be identifiers of a terminal such as the terminal 105 and/or a server such as the server 104.

The device S also comprises a module DETER1 able to determine, depending on the obtained connectivity data, an access parameter for access to a communication device. The access parameter is, for example, a parameter allowing a communication to be established, such as an IP address, with a communication device such as, for example, the server 106.

According to one particular embodiment, the device S comprises a storage space able to store the notifications received via the module RECV1.

FIG. 3 shows the steps of the method for transmitting a notification according to one particular embodiment of the invention. FIG. 3 uses the same environment as described with reference to FIG. 1.

During a first step E10, the application server 101 sends a notification to an application run on the terminal 105 or to a security element used by the terminal 105. In step E20, the server 102 which carries out the method for transmitting a notification receives the notification which can comprise one or more identifiers of the terminal 105. This identifier is, for example, the MSISDN associated with the SIM/eSIM card of the terminal or the IMEI of the terminal or an IP/MAC/etc., address. The notification can also comprise one or more identifiers of the receiving application.

According to one particular embodiment, the server 101 can determine, on the basis of the identifier(s) of the terminal, the telecommunication operator responsible for the communications with the terminal 105, for example by consulting an MSISDN call number portability database (not shown). Once the telecommunication operator has been identified, the server 101 then determines the server 102 of the telecommunication operator to be contacted.

In step E21, the method transmits a request to a database 103 in order to obtain one or more connectivity data. Specifically, the method prompts, for example, the execution of an SQL request (E31) in the database 103 using one or more identifiers of the terminal 105 retrieved in the notification as the search key.

It should be noted that, if the server 102 is not a server operated by the telecommunication operator of the network 100 and is not therefore a server located within the network 100, the method can also determine the telecommunication operator responsible for the communications with the terminal 105 on the basis of the identifier(s) of the terminal contained in the notification. Once the telecommunication operator has been identified, the server 102 then determines the database 103 of the telecommunication operator to be consulted.

It should be noted that the method can also generate a new identifier on the basis of the identifiers of the terminal 105 contained in the notification in order to carry out the search, for example by concatenating a plurality of identifiers. The method can also obtain a new identifier in order to carry out the search depending on the identifier(s) contained in the notification, for example from a storage space or via a network request. The notification can thus comprise, for example, the MAC address of the terminal 105, thus providing the MSISDN of the terminal 105 which will then be used to search the connectivity data in the database 103.

Alternatively, the connectivity data can also be obtained from a storage space of the server 102, such as, for example, a memory, or via a network request.

Alternatively or cumulatively, in step E21, the method prompts, for example, the execution of an SQL request (E31) in the database 103 using one or more identifiers of the server 104 as the search key.

Alternatively or cumulatively, in step E21, the method prompts, for example, the execution of an SQL request (E31) in the database 103 using one or more identifiers of the application receiving the notification as the search key. This serves, for example, to choose one connectivity from among a plurality of connectivities available on the terminal 105 depending on the application receiving the notification. It is thus possible to choose the most suitable connectivity for the transmission of the notification, such as, for example, the fastest or the least energy-intensive.

In step E32, the connectivity data are sent by the database 103 and are received by the server 102 in step E22.

The connectivity data are, for example, retrieved in the form of a list, ordered or otherwise, detailing some or all of the communication interfaces/services of the terminal 105 and/or of the server 104 with their state (active/inactive). Specifically, these data can be IP addresses, particular communication modes, such as, for example, USSD/SMS/telephony/etc., or any type of information relating to the establishment of a communication with the terminal 105 and/or the server 104.

According to one particular embodiment of the invention, these data can also comprise rights governing the use of the communication interfaces/services by the terminal 105. The owner of the terminal 105 can in fact be authorized or not by the telecommunication operator to use a communication interface/service of his terminal (105). These rights are linked, for example, to the commercial offering to which the owner of the security element used by the terminal 105 subscribes with the telecommunication operator which operates the telecommunication network 100.

In step E22, the connectivity data are processed by the method for transmitting a notification. The method checks, for example, that the server 104 is contactable and that at least one of its connectivities is active. In this case, the method can decide to send (E25) the notification to the server 104. The server 104 is, for example, an Apple (APNS) or Google (GCM/FCM) notification platform. These platforms use an identifier/token contained in the notification and assigned to the application when it is downloaded onto the terminal 105 in order to identify the terminal 105 and the receiving application. The identifier/token has obviously been transmitted in advance by the application run on the terminal 105 to the application server 101.

This token is stored, for example, in a database accessible from the server 104 with the current connectivity context of the terminal 105, such as its IP address. If a new IP address is assigned to the terminal 105, the OS of the terminal or an application of the terminal 105 forwards the new address to the server 104.

It should be noted that if the implementation environment consists of a plurality of notification servers, for example an APNS (Apple) server 104 and a GCM/FCM (Google) server 104′ (not shown here), the method for transmitting a notification can comprise an additional step (not shown) of determining the server compatible with the terminal 105. The notification servers are in fact associated with a particular ecosystem and are not interoperable. An APNS server can only notify a terminal which is part of the Apple environment (e.g. an iOS terminal), and a GCM/FCM server can only notify a terminal which is part of the Google environment (e.g. an Android terminal). This determination step can be carried out, for example, on the basis of the IMEI contained in the notification. The server 102 infers the terminal type and consequently the compatible server therefrom.

The notification is sent by the server 102 in step E25 and is then received by the server 104 in step E55. The server 104 then identifies the receiving terminal and application by means of the token contained in the notification. The notification is then transmitted to the terminal 105 in step E56 and is then received by the terminal 105 in step E66. Once received, the notification is intercepted by the OS of the terminal and/or an application run by the terminal, such as, for example, the Google Play Store application. The OS/Store application of the terminal then uses a notification API local to the terminal in order to notify the user. This notification can take place in a plurality of forms, such as, for example, the display of a window in the upper part of the terminal with a text contained in the notification and/or action buttons and/or the superimposed display of a graphical element over the icon of the application receiving the notification and/or the output of a sound or vibration in the terminal, etc.

At the end of step E22, the method can also decide not to send the notification to the server 104, for example because the connectivity data indicate that this server is not contactable, i.e. none of its communication interfaces is connected or active or because the method prioritizes the transmission of the notification to the terminal 105 via the server 106. The notification method then processes the connectivity data relating to the terminal 105. The method extracts, for example, the communication modes available on the terminal 105 from the connectivity datum/data and then has knowledge of all of the communication interfaces/services (SMS, USSD, MMS, IP, telephony, RCS, etc.) of the terminal 105 with their states (active/inactive/etc.). The connectivity data can also comprise a quality indicator for each communication interface of the terminal 105, such as, for example, the required minimum radio signal level, a connection failure rate, the latency determined before obtaining an acknowledgement of receipt of the notification, etc.

It should be noted that the SDM (Subscriber Data Management HLR (Home Locator Register)/HSS (Home Subscriber Server)) present in the communication network 100 (not shown) of the operator has knowledge of all of the communication interfaces/services available for each terminal connected to the network 100 via the security element of the terminal.

The method then chooses a communication interface/service of the terminal 105, for example depending on the state and/or an order of priority to be used and/or a quality indicator to communicate and transmit the notification to the terminal 105. Once the communication interface has been selected, the method then infers/determines an access parameter therefrom for access to a communication device in order to communicate with the terminal 105 via the chosen communication interface. If the method determines, for example, that the communication interface is an SMS interface/service, the access parameter will then be, for example, the IP address or FQDN (Fully Qualified Domain Name) or URI (Uniform Resource Identifier) of an SMS-C platform shown here by the server 106. The access parameters are stored, for example, in a digital storage space such as a database (103) or a file located on the server 102. In step E23, the method then transmits the notification to the communication device such as the server 106.

According to one particular embodiment, if the server 102 is not a server operated by the telecommunication operator of the network 100 and is not therefore a server located within the network 100, the method can then determine, in step E23, on the basis of the identifier(s) of the terminal contained in the notification, the telecommunication operator responsible for the communications with the terminal 105, for example by consulting an MSISDN call number portability database (not shown). Once the telecommunication operator has been identified, the server 102 then determines the communication device of the telecommunication operator to be contacted (e.g. the server 106).

The notification is then received in step E43 by the communication device and is then processed in order to route/send the notification to the terminal 105. To do this, the device can retrieve an identifier of the terminal 105, for example contained in the notification, such as the MSISDN or IMSI, and can then generate a message in a format suitable for sending it (E44) to the terminal 105. The notification is then received by the terminal 105 in step E64.

Once the notification has been received, for example on the mobile radio interface of the terminal, the software drivers of the hardware components of the terminal ensure that the radio telecommunication services with the network of the mobile operator receive the notification which can be, for example, a radio signaling message (low/hardware layers of the OSI model) or a higher-level message, for example a TCP/IP or NAS or IMS message. These components/drivers/software layers (middleware) are able to manage different types of telephony service, messaging, USSD/USSI code or notification (for example a “paging” broadcast message to search for a mobile terminal in idle mode in a plurality of radio cells in order to establish a unicast communication with this terminal, or an NAS (Network Access Stratum) notification message) for the application requirements for telephony (circuit mode/packet mode with VoLTE (Voice over LTE)/VoWiFi (Voice over WiFi)/VoNR (Voice over New Radio)/etc.), for messaging (Short Message Service over Circuit Switch/Short Message Service over GS Interface/Short Message Service over Mobility Management Entity/Short Message Service over IP/RCS in IP mode), for USSD/USSI code processing or for the NAS (Network Access Stratum) signaling notification mechanisms of the terminal 105. These types of applications in fact have particular privileges in the OS of the terminal and have permanent access to the different low-level protocols of the cellular/WiFi mobile networks (for example the NAS protocol, IMS SIP protocol stack, etc.), allowing them to be woken up and/or activated automatically with an incoming event (signaling message) with no need for the conventional application notification mechanism. The notification is therefore received by one of these applications depending on the chosen communication interface/service and communication device. Once received, the notification is then processed, for example, by a messaging application (SMS) or telephony application of the terminal. The processing can specifically comprise the search for a particular element/parameter in the notification indicating that said notification is intended to be transmitted to another application. In the case of a messaging (SMS) or telephony application, the processing can comprise, for example, searching in the notification for a predefined transmitting calling number inserted in advance by the communication device/server 106 or for an application identifier. This in fact involves a notification intended for an application to be notified, i.e. a predefined transmitting calling number and/or an application identifier is/are actually present in the notification, in which case the behavior of the application which carries out the processing is modified so that the notification is not processed as a message/SMS or a conventional call. The call logs, for example, or the user interfaces of the messaging (SMS) or telephony application are not then updated so that this processing remains invisible to the user.

The messaging (SMS) or telephony application then uses a notification API local to the terminal 105 in order, for example, to notify the user via the application receiving the notification. This notification can take place in a plurality of forms, such as, for example, the display of a window in the upper part of the terminal with a text contained in the notification and/or action buttons and/or the superimposed display of a graphical element over the icon of the application receiving the notification and/or the output of a sound or vibration in the terminal, etc. The SMS or telephony application can also determine that the application receiving the notification must be woken up, and can wake it up by transmitting to it, for example, the notification received via an API local to the terminal 105, for example via Deeplink (specific link aiming to direct to a precise page or product rather than redirecting only to the home page of the application) or Applink mechanisms supplied by the operating systems of the mobile terminals.

According to one particular embodiment, the notification can be received in an application running on the security element (Applet or Cardlet). The application is then able to notify the user of the terminal 105 directly via, for example, a SIM Toolkit API. The application can also determine an application to be woken up depending on an identifier of the receiving application contained in the notification, and can wake it up by transmitting to it, for example, the received notification.

According to one particular embodiment of the invention, the identifier of the application contained in the notification can comprise a link allowing access to a specific content of the application, such as, for example, a heading or a particular element.

According to one particular embodiment of the invention, the identifier of the application contained in the notification can comprise a link enabling the application to download a datum/information element from a server located in the network. Specifically, in step E20, the method can consider that the notification comprises a content which is, for example, too large, and can decide to store it in a digital storage space such as the database 103. In step E23, the sent notification is modified in advance by the transmission method in order to remove the large content and insert a unique identifier of the notification therein, for example in the form of a URL link which will allow the communication application receiving the notification or the receiving application to download the original content. It should be noted that the identifier of the notification can also comprise the identifier of the application in the form of a download link.

The embodiment described above has obviously been given as purely indicative and in no way limiting, and many modifications can easily be made by the person skilled in the art without departing the scope of the invention.

1. A method for transmitting a notification to an application of a mobile terminal, said mobile terminal having a secure hardware element allowing the authentication of said mobile terminal in a telecommunication network, the method comprising:
receiving said notification from an application server, said notification comprising at least one identifier of said mobile terminal and at least one identifier of said application;
obtaining at least one connectivity datum depending on said at least one identifier of said mobile terminal;
determining, depending on said at least one obtained connectivity datum, an access parameter for access to at least one communication device able to communicate with said mobile terminal; and
transmitting said notification to said communication device accessible via said access parameter.

2. The of claim 1, characterized in that the transmission step comprises a substep of routing said notification by said communication device to said application of said mobile terminal identified via said at least one identifier of said mobile terminal.

3. The method of claim 1, wherein the obtaining step also depends on said identifier of said application.

4. The method of claim 1, wherein the reception step is followed by a step of storing said notification.

5. The method of claim 1, wherein said at least one connectivity datum comprises a connection state of at least one communication interface of said mobile terminal at a given time.

6. The method of claim 1, wherein said at least one connectivity datum comprises a priority indicator associated with said at least one communication interface of said mobile terminal.

7. The method of claim 1, wherein said at least one connectivity datum comprises a quality indicator associated with said at least one communication interface of said mobile terminal.

8. The method of claim 1, wherein the determination step also depends on an access rights datum associated with the secure hardware element.

9. The method of claim 1, wherein said at least one connectivity datum comprises a connection state of at least one server located in the network.

10. A device for transmitting a notification to an application of a mobile terminal, said mobile terminal having a secure hardware element allowing the authentication of said mobile terminal in a telecommunication network, said device comprising:
a module for receiving said notification from an application server, said notification comprising at least one identifier of said mobile terminal and at least one identifier of said application;
a module for obtaining at least one connectivity datum depending on said first identifier of said mobile terminal;
a module for determining, depending on said at least one obtained connectivity datum, an access parameter for access to at least one communication device able to communicate with said mobile terminal;
a module for transmitting said notification to said communication device via said access parameter.

11. The device of claim 10, wherein the device includes said communication device.

12. A system for transmitting a notification to an application of a mobile terminal, said mobile terminal having a secure hardware element allowing the authentication of said mobile terminal in a telecommunication network, the system comprising:
a first device comprising means for receiving said notification from an application server, said notification comprising at least one identifier of said mobile terminal and at least one identifier of said application, obtaining at least one connectivity datum depending on said identifier of said mobile terminal, determining an access parameter for access to at least one communication device depending on said at least one obtained connectivity datum, and transmitting said notification to said communication device;
a communication device, accessible via said access parameter comprising means for receiving said notification and routing said notification to said mobile terminal depending on said at least one identifier of said mobile terminal.

13. The system of claim 12, wherein said communication device comprises a server of a telecommunication operator able to communicate with said mobile terminal.

14. A non-transitory computer-readable medium having stored thereon instructions which, when executed by a processor, cause the processor to implement the method of claim 1.
